(19) United States
(12) Patent Application Publication
(10) Pub. No.: US 2005/0288043 A1
(43) Pub. Date: Dec. 29, 2005

(54) Method for preventing PHS mobile phones from being stolen by using remote control function of short message service

(75) Inventors: Cheng-Shing Lai, Taipei Hsien (TW); Hong-Bao Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/873,201

(22) Filed: Jun. 23, 2004

(51) Int. Cl. H04M 3/16; H04Q 7/20

(52) U.S. Cl. 455/466; 455/410; 455/414.1

(57) ABSTRACT

The present invention is to provide a method for preventing a PHS mobile phone from being stolen by using a remote control function of the short message service. The invention utilizes a short message service platform to send out a short message for controlling a short message option of the PHS mobile phone and restrict the priority of using the lost or stolen PHS mobile phone. A message is displayed on a display interface to indicate that the mobile phone is lost or stolen. Such arrangement provides further protections to the owner of the lost or stolen phone, reduces the loss and stops the illegal disposal of the stolen goods.

### FIELD OF THE INVENTION

The present invention relates to a method for preventing a mobile phone from being stolen, more particularly to a method for preventing a PHS mobile phone from being stolen by using a remote control function of the short message service.

### BACKGROUND OF THE INVENTION

At present, our world enters into a blooming message and knowledge era and the information exchange and communications between people become more and more important. With the arrival of the network era, network and telecommunication technologies such as the mobile telecommunication and wireless telecommunication are developed and popularized quickly. The wireless device serves as a modern advanced telecommunication tool and progressively plays an important role in our work and daily life, which is an unsubstitutable product. However, the short message service function leverages its simple, easy-to-use, fast and convenient advantages and gradually becomes another important common information communication measure in addition to its voice phone function.

Further, as the electronic industry progresses, various electronic products including consumer electronic products such as the global system for mobile communications (GSM) and the low power personal handyphone system (PHS) mobile phones are introduced successively to the market. With a smaller and more compact design and a decreasing price, the wireless telecommunication and network services unreachable in the past is available easily now. They also become an important part of our work and life for most people. The PHS mobile phone is a telephone system introduced to the market by Japan in 1995, which belongs to a low power telecommunication system with basic functions similar to those of the GSM mobile phone system. The difference resides on that the PHS utilizes a microcell base station to transmit signals, and thus having a smaller coverage and a slower mobility, which better suits the population of the urban areas.

However, it is believed that many people have some bad experience on losing their mobile phone or having their mobile phone stolen. Regardless of the PHS mobile phone or the GSM mobile phone, users can only report their loss according to the method given by the telecommunication company to minimize any possible loss of telephone charges when their mobile phone is lost or stolen. However, it is very difficult if not impossible to recover the mobile phone. Therefore, criminals can sell the lost or stolen mobile phone illegally for money, and thus causing more crimes of stealing mobile phones and definitely affecting the crime rate of our society, which bothers the police and citizens very much. Further, since the PHS mobile phone is unlike the GSM mobile phone that separates its phone system with the subscriber identification module (SIM) card. In other words, the phone number of the PHS mobile phone is written inside the PHS mobile phone. Unless the phone number in the PHS mobile phone is changed and a new number is assigned to the PHS mobile phone by the telephone company, the old phone number stays with the PHS mobile phone. Even a thief steals the PHS mobile phone and turns off the phone, the phone number remains unchanged. Therefore, such design aims at the special properties of the PHS mobile phone and uses the short message service function of the general mobile phone to provide a remote control method for preventing the PHS mobile phone from being stolen. With such design, a short message will be sent from the owner of the lost phone immediately as soon as the thief turns on the PHS mobile phone. The present invention can reduce the loss of telephone charges and effectively prohibit illegal disposal of stolen goods.

### SUMMARY OF THE INVENTION

In view of the detailed description of the prior arts, it is not difficult to understand that most people report their loss of the mobile phone to the telephone company when their mobile phone is lost or stolen, but still worry about any possible loss on telephone charges. Furthermore, it is difficult to recover the lost phone, or the thief even sells the stolen phone illegally. The inventor of the present invention based on years of experience in the related industry to conduct extensive researches and experiments to meet the actual requirements of the market and overcome the foregoing shortcomings, and finally invented the method for preventing a PHS mobile phone from being stolen by using the remote control function of a short message service in accordance with the invention. With such ingenious idea, even when a PHS mobile phone is stolen, the owner of the lost phone can send out a short message to reduce the loss and stop the illegal disposal of stolen goods, and provides further protections to the owner of the lost phone.

The primary objective of the present invention is to provide a method for preventing a PHS mobile phone from being stolen by using the remote control function of a short message service, which uses a short message service platform such as a mobile phone, a computer network, or a fixed phone having a network function, etc to send out a short message for controlling a short message option in the PHS mobile phone and restrict the priority of using the lost PHS mobile phone, and display a message on a display interface to indicate that the mobile phone is a lost or stolen one. Such arrangement provides further protections to users (in this case, the owner of the lost or stolen phone) and reduces the loss and stops the illegal disposal of stolen goods, and also effectively overcomes the shortcomings of the prior art.

The above and other objects, features and advantages of the present invention will become apparent from the following detailed description taken with the accompanying drawings.

### BRIEF DESCRIPTION OF THE DRAWINGS

FIG. 1 is a block diagram of the processing components of the present invention.

FIG. 2 is a flow chart of the present invention.

### DETAILED DESCRIPTION OF THE PREFERRED EMBODIMENTS

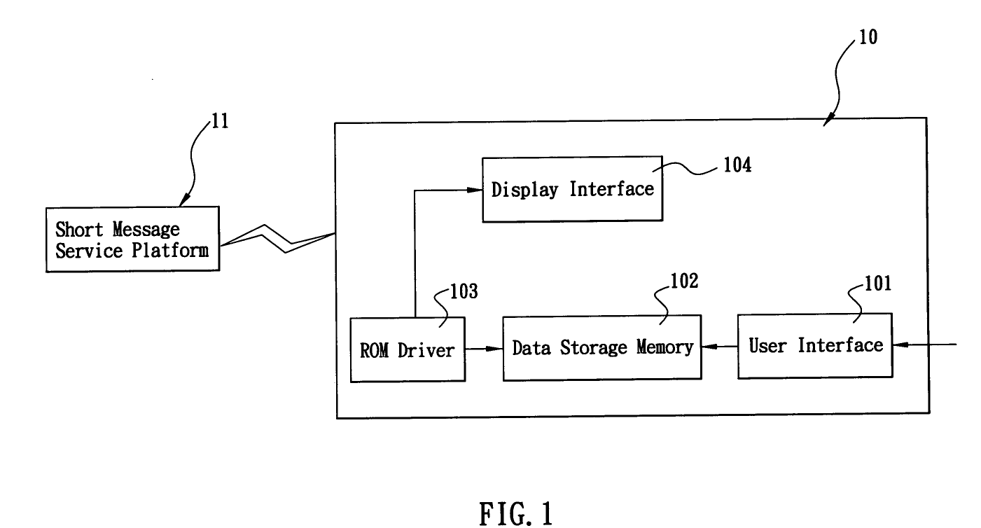

Please refer to FIG. 1 for the method for preventing a PHS mobile phone from being stolen by using a remote control function of the short message service. The method allows users to use a user interface (UI) 101 of a low power personal handyphone system (PHS) mobile phone 10 to set up at least one set of short message option parameters into a data storage memory 102, and after the PHS mobile phone 10 receives a short message for controlling the short message option parameters issued by a short message service platform 11, the driver program stored in the read only memory (ROM) 103 of the PHS mobile phone 10 will compare the content of the short message for the control and the short message option parameters stored in the data storage memory 102, and then determines whether or not to enable a corresponding priority setup. Therefore, if any one of the priority setups is enabled, a specific message will be displayed on a display interface 104. In the meantime, each function module of the PHS mobile phone 10 will be restricted according to the setup of the priority of the specific message in order to achieve the objective of using the remote control function of a short message service to prevent the PHS mobile phone 10 from being stolen.

The present invention comprises at least one set of short message options parameters, which can be preset according to the content of some uncommonly used functions, and the content such as a set of passwords can be modified anytime. The content could be a function prohibiting anyone from making a call, checking a private message, or receiving a call from the PHS mobile phone 10.

Further, the present invention can display a specific message on the display interface 104 of the PHS mobile phone 10 to indicate that the PHS mobile phone 10 is lost or stolen (or show the information of the mobile phone being locked). The content of the specific message can be fixed or preset by users and the content of a short message is sent out from the short message service platform 11. Of course, a continuous alarm ring can be issued as well.

When the PHS mobile phone 10 according to the present invention is lost or stolen, the short message service platform 11 is used to send out a short message from a remote end to control the short message option and enable the priority setup of the lost or stolen PHS mobile phone 10. The driver program saved in the ROM 103 will compare the content of the short message for controlling the short message option and the short message option parameters stored in the data storage memory 102, and then determines whether or not a corresponding priority should be enabled; if yes, then the execution of each function module of the PHS mobile phone 10 is restricted according to the content of the enabled short message option parameters. For example, the PHS mobile phone 10 prohibits anyone to make a call, check on a private message, or receive a call from the PHS mobile phone 10. A message of indicating that the PHS mobile phone 10 has been lost or stolen (such as indicating that the owner of the lost mobile phone has locked the phone) can be displayed on the display interface 104, and a continuous alarm ring can be issued by the PHS mobile phone 10.

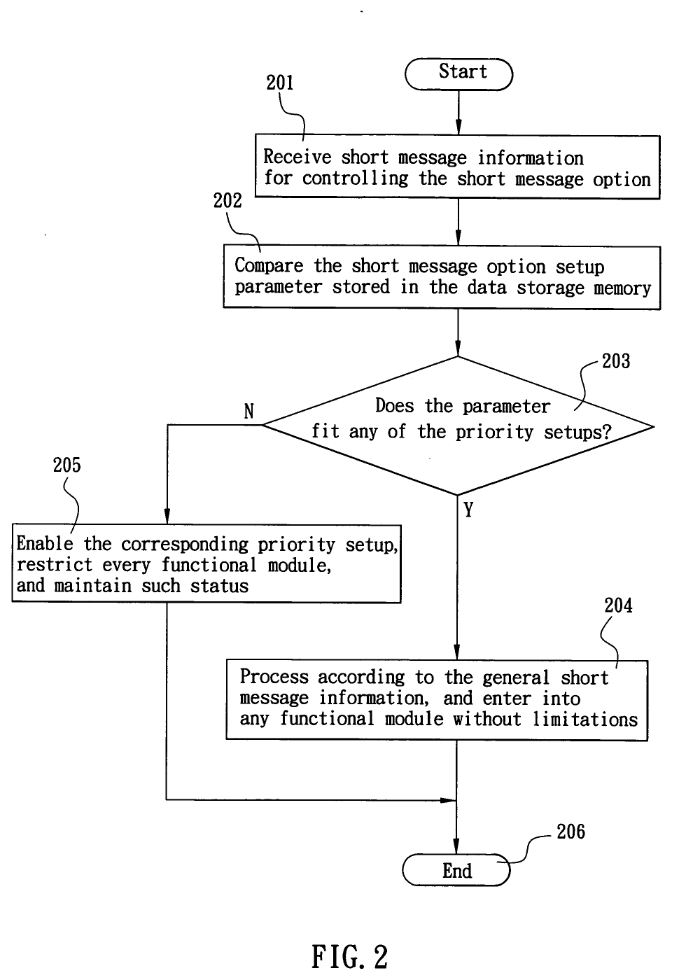

If the PHS mobile phone 10 is lost or stolen, a user (that is the owner of a lost phone) can send out a short message for controlling the short message option from a remote end through the short message service platform 11 and the driver program installed in the PHS mobile phone 10 proceeds the following steps as shown in FIG. 2:

Step (201): Receive a short message for controlling the short message option.

Step (202): Read the content of the control short message and compare the short message option parameters stored in the data storage memory 102.

Step (203): Determine whether or not the content is the same as any of the priority setups of the short message option parameters; if yes, go to Step (204); and if no, go to Step (205).

Step (204): Enable a corresponding priority setup and display a message (such as the message prohibiting users to make a call, read a private message or receive a call from the mobile phone) or a specific hint (such as the message indicating that the owner of the lost phone has locked the phone) on the display interface 104, or issue a continuous alarm ring, etc. In the meantime, the each function module of the PHS mobile phone 10 is restricted for its use according to the priority setup of the specific message, and maintains such status, and then goes to Step (206).

Step (205): Process according to the regular short message information, and enter each function module of the PHS mobile phone 10 without restrictions, and then go to Step (206).

Step (206): End the process.

With the detailed description above, the examiner should be familiar with the present invention. The following real-life example is given to let our examiner have a better understanding about the invention.

For example, Mr. Wu sets at least one set of short message option parameters to a data storage memory 102 in the mobile phone 10 through a user interface 101, and the short message option parameters have the following short message content:

(1) Short message “1” reads “Prohibit making a call from this PHS mobile phone 10 and restrict the PHS mobile phone 10 to enter other interface.”

(2) Short message “2” reads “Prohibit making a call from this PHS mobile phone 10.”

(3) Short message “3+Hint content” shows the content of a hint on the PHS mobile phone 10, such as “This phone is stolen, and the phone holder is a thief.”

With such design, when Mr. Wu discovers that his PHS mobile phone 10 is missing or stolen, he can send a short message for controlling the short message option from a remote end of the short message service platform to the PHS mobile phone 10, and exercises the priority setup for the lost or stolen PHS mobile phone 10. The driver program of the PHS mobile phone 10 sends out Mr. Wu's short message according to the following procedure:

Mr. Wu sends the short message “1” to prohibit anyone to make a call from the PHS mobile phone 10 and restrict the PHS mobile phone 10 to enter into other interfaces.

Mr. Wu dials the phone number of the PHS mobile phone 10 and attempts to contact with the mobile phone holder (since the mobile phone may not be stolen, such arrangement facilitates the owner of the lost phone can contact the phone holder to recover the lost phone.) If it is found that the mobile phone 10 is stolen and the lost phone cannot be recovered anymore, then the short message “3+This phone is stolen, and the phone holder is a thief” will be sent. Therefore, other people will know that such phone is a stolen one, and then Mr. Wu still can call that number to negotiate with the opposite party. If the negotiation fails, then Mr. Wu can send the short message “2” to prohibit anyone to receive a call from the PHS mobile phone 10. Therefore, such phone 10 is simply useless to the thief.

If the thief turns off the phone 10 immediately after the thief has stolen the phone 10, then the short message center will temporarily save the short message to be sent to the low power PHS mobile phone 10. As soon as the PHS mobile phone 10 is turned on again, the short message will be sent immediately.

From the above description, it is clear that the major feature of the invention resides on that if a user's PHS mobile phone 10 is lost or stolen, the user can send out a short message for controlling the short message option from a remote end to the PHS mobile phone 10 through the short message service platform 11 and exercises the priority setup on the lost or stolen PHS mobile phone 10, and displays a message on the display interface 104 to indicate that the PHS mobile phone 10 is lost or stolen. The content of the hint message helps others to identify that such PHS mobile phone 10 is a lost or stolen one, which is similar to stamping “Counterfeit” on a fake dollar bill. Therefore, no phone call can be made from such PHS mobile phone 10, and the phone number cannot be changed. Such PHS mobile phone 10 is useless to the thief, and thus providing further protections to the owner of the PHS mobile phone 10, minimizing the owner's loss, and stopping illegal disposal of stolen goods. The design of this invention can effectively overcome the shortcomings of the prior art, and the invention is definitely a humanistic design.

While the invention has been described by means of specific embodiments, numerous modifications and variations could be made thereto by those skilled in the art without departing from the scope and spirit of the invention set forth in the claims.

1. A method for preventing PHS mobile phones from being stolen by using remote control function of short message service, comprising the steps of:
setting up at least one set of short message option parameters in a data storage memory by a user through a user interface of a PHS mobile phone;
comparing the content of a short message information for controlling said short message option parameters issued by a short message service platform by a driver program in a read only memory and said short message option parameters after said PHS mobile phone receives said short message option parameters stored in said data storage memory; and
determining if it is necessary to enable a corresponding priority setup;
thereby when any of said priority setups is enabled, a specific message is displayed on a display interface while said PHS mobile phone restricts the use of each function module according to said priority setup described in said specific message for preventing said PHS mobile phone from being stolen.

2. The method for preventing PHS mobile phones from being stolen by using remote control function of short message service of claim 1, wherein said at least one set of short message option parameters presets a certain uncommonly used content according to the user's practical need, and said content is alterable anytime for prohibiting said PHS mobile phone from selectively making a call, checking a private message and receiving a call.

3. The method for preventing PHS mobile phones from being stolen by using remote control function of short message service of claim 1, wherein said specific message displayed on said display interface of said PHS mobile phone is a message selectively from a lost and a stolen PHS mobile phone and the content of said specific message is selectively fixed and preset by users.

4. The method for preventing PHS mobile phones from being stolen by using remote control function of short message service of claim 1, wherein said short message information transmitted from said short message service platform is an alarm ring continuously issued by said PHS mobile phone.

5. The method for preventing PHS mobile phones from being stolen by using remote control function of short message service of claim 1, wherein said driver program installed in said PHS mobile phone processes the following procedure when said short message sent by users for controlling said message option through a remote end of said short message service platform:
receiving said short message information for controlling said short message option;
reading the content of said control short message and said short message option parameter stored in said data storage memory for a comparison;
determining whether said content being the same as any of said priority setups in said short message option parameters; if yes, then enable a corresponding priority setup and display a message on said display interface and restrict the use of each function module of said PHS mobile phone according to the setup of said specific message priority, and maintain said status; and
ending said procedure.

6. The method for preventing PHS mobile phones from being stolen by using remote control function of short message service of claim 5, wherein said each function module of said PHS mobile phone is performed according to said short message information without restrictions, when said content is determined not the same as any one of said priority setups of said short message option parameters.

7. The method for preventing PHS mobile phones from being stolen by using remote control function of short message service of claim 5, wherein said short message service platform is one selected from the collection of a mobile phone, a computer network and a fixed phone having a network function.
